(19) United States
(12) Patent Application Publication
(10) Pub. No.: US 2015/0032503 A1
(43) Pub. Date: Jan. 29, 2015

(54) System and Method for Customer Evaluation and Retention

(71) Applicant: Decisive Analytical Systems Private Ltd., Bangalore (IN)

(72) Inventors: Soundararajan Vijay Chander, Bangalore (IN); Raju Veerendra Hittenhallikoppalu, Bangalore (IN)

(21) Appl. No.: 14/337,324

(22) Filed: Jul. 22, 2014

(30) Foreign Application Priority Data
Jul. 23, 2013 (IN) 3266/CHE/2013

(51) Int. Cl. G06Q 30/02

(52) U.S. Cl. CPC G06Q 30/0201
USPC 705/7.29

(57) ABSTRACT

The present invention provides a system and method for customer evaluation and retention. The system is adapted to receive and record all data concerning customer's interaction during the transaction from various touch points and sends the data to a server for further processing. The scoring module of the system allocates values to each customer by assigning score based on various scoring attributes. The final updated information about each customer is pushed back to all touch points that will be further used by business owners for formulating customer retention programs. The availability of real time information regarding customer net present value is beneficial in computing and proposing retention program as the evaluation data is based on past trends taking into consideration recency, frequency, monetary history and individual sentiment scores.

### DESCRIPTION OF THE INVENTION

The following specification particularly describes the invention and the manner in which it is to be performed.

### FIELD OF THE INVENTION

The present invention relates to a system and method for evaluating individual customers based on their purchasing behavior at different places. More specifically, the invention relates to a system and method to evaluate scores for respective customers, doing transactions at different touch points, based on different attributes and making real time data available to the different touch points that assist the business owners to come up with better customer retention programs.

### BACKGROUND OF THE INVENTION

In today's world owing to increased living standards and increased income, more and more people indulge into shopping. There are various shopping options available in the market like physical shopping i.e. going in person to the store, shopping over the internet and for making this entire shopping process comfortable, there are available a number of ATMs and bank outlets etc. for the customer to do transactions easily anytime and anywhere. Nowadays e-commerce has made it possible to do online shopping over any portable devices such as laptops, mobile phones, tablets etc. with ease. People are exploring different sources of transactions as per their comfort and likes.

In the present scenario, it is very difficult for the shopkeepers or bank or other business owners to maintain healthy relationship with customers, identify potential customers and retain them. The problem gets worsened when people are not consistent with one transaction source, as they are exploring various sources for shopping and money transactions as per their comfort. In the current scenario it is very difficult to maintain data related to respective customers regarding their money transactions and purchasing pattern. This data can play a significant role for various business owners in retaining their potential customers that in turn will lead to increased revenue and profit.

In the current state-of-the-art, there exist lots of customer evaluation methods which work on scoring model taking into consideration some attributes of the customer. Some of these methods are correlation, customer relationship analysis (CRA), data-driven decision management (DDDM), Digital Silhouettes, PMML (Predictive Model Markup Language), data-driven disaster, real-time analytics, Plutchik's wheel of emotions, click stream analysis, customer segmentation etc.

In presently available systems and method for customer evaluation, the customer touch-point applications are disparate and data is collected in disparate sources. So the business needs to align both these sources to get customer behavior across these sources. To calculate customer value and to deliver customer insights in real time, all customer data needs to be aligned which are available through various sources. Once the data is aligned, either data scientist analyzes for insights or uses models to auto-segment customers based on behavior/transactions or interactions. The derived insights are further processed for next actions with the customer.

In a prior art application no W00068860A2 a system and method of social network generation is described for determining the value of the customer or a group of customers based on different criteria as desired by the users. Customers detail based on household and organization is recorded. The recorded data for individual customers is organized and analyzed for recognizing potential customers and develop long term relationship with the customer. The above method fails to receive and record data of individual customer from varied sources that can provide better insight to the user and can prove to be more beneficial.

In a prior art application no US2008288339A1 a system and method for improving customer retention is explained which focus on each and every activity performed by a customer in respect of opening account etc. and target these specific customers with product offers that increases the likelihood of revenue generation. The above mentioned method fails to take into account other attributes for purpose of customer retention such as sentiments which can prove to be very valuable in terms of generating long term relationship with customer.

There also exist many customer retention strategies in the state-of-the-art as explained below.

Reducing attrition that means virtually every business loses some customers, but few ever measure or recognize how many of their customers become inactive. Most businesses, ironically, invest an enormous amount of time, effort and expense building that initial customer relationship. Then they let that relationship go unattended, in some cases even losing interest as soon as the sales has been made, or even worse, they abandon the customer as soon as an easily remedied problem occurs, only to have to spend another small fortune to replace that customer. The easiest way to grow a business is not to lose the customers. Once the leakage is stopped, it's often possible to double or triple the growth rate. All the above mentioned systems and methods for customer evaluation and retention lack an ability to integrate customer data available from different sources to create one unified profile. Unification of Customer Data is necessary to understand and retain customers and their value in terms of revenue, profits and risks.

There are no accurate calculations of customer value in real-time since the sources are different which makes difficult for scoring interactions and behavior of customers. The customer retention models available in the state-of-the-art do not take into account the customers sentiments which is very important in terms of building long term relationship with the customers.

Hence looking at the state-of-the-art methodologies available for customer evaluation and retention, there is a need of a system and a method which can calculate insights of a single customer based on data collected across all touch-points, thus enabling unified customer data. The obtained collective data may be further used by the scoring model that assigns score and auto segregate customers based on various attributes like customer behavior, interactions and make the data available to various touch points on real time basis that automates the process for customer retention programs that helps in saving time and resources of the business owners.

### SUMMARY OF THE INVENTION

The present invention provides a system and method for customer evaluation and retention. A system and method can be configured to receive and record customer's interaction data during a transaction at any of the touch points which includes store, kiosk, online over website or mobile. The recorded data is sent to the server for processing and scoring. The system is configured to value customers by scoring them based on customer's interaction, behavior and transactions. Scoring is done each time the data gets updated, in this way customer's net present value is available to all touch points as the system is configured to send the updated customer's information back to the touch points. This real time updated data regarding each customer helps the business owner to compute and propose better customer retention plans and the business owners are benefitted by the system as the system not only analyzes retention factors based on recency, frequency and monetary (RFM) value but also takes into account sentiments while valuating customers.

### BRIEF DESCRIPTION OF THE DRAWINGS:

The foregoing and other features of embodiments will become more apparent from the following detailed description of embodiments when read in conjunction with the accompanying drawings. In the drawings, like reference numerals refer to like elements.

FIG. 1 is a block diagram which illustrates the sample network environment within which system for string generation and consumption methods are implemented in accordance to one or more embodiments of the invention.

FIG. 2 is a block diagram which illustrates the agent software component of the system for customer evaluation and retention in accordance to one or more embodiments of the invention.

FIG. 3 shows a table depicting the example parameters of dynamic interaction recorder module in context of store in accordance to one or more embodiments of the invention.

FIG. 4 shows a table depicting the example parameters of dynamic interaction recorder module in context of call center in accordance to one or more embodiments of the invention.

FIG. 5 shows a table depicting the example parameters of dynamic interaction recorder module in context of online interactions and transactions in accordance to one or more embodiments of the invention.

FIG. 6 shows a table depicting the example parameters of scoring module in context of different attributes in accordance to one or more embodiments of the invention.

FIGS. 7A-7B show a table depicting an example parameters of indexed and calculated vectors used by the customer evaluation and customer retention identification system and containing values associated with a particular customer in accordance to one or more embodiments of the invention.

FIG. 8 shows a flowchart depicting steps of a method for data progression in accordance to one or more embodiments of the invention.

### DETAILED DESCRIPTION OF THE INVENTION

The present invention overcomes the drawback of the customer evaluation and customer retention system available in the state of the art by providing a system which evaluates individual customer based on transactions taking place at various touch points and delivers real time updated customer information to these touch points that assist the business owners to come up with efficient real-time customer retention programs.

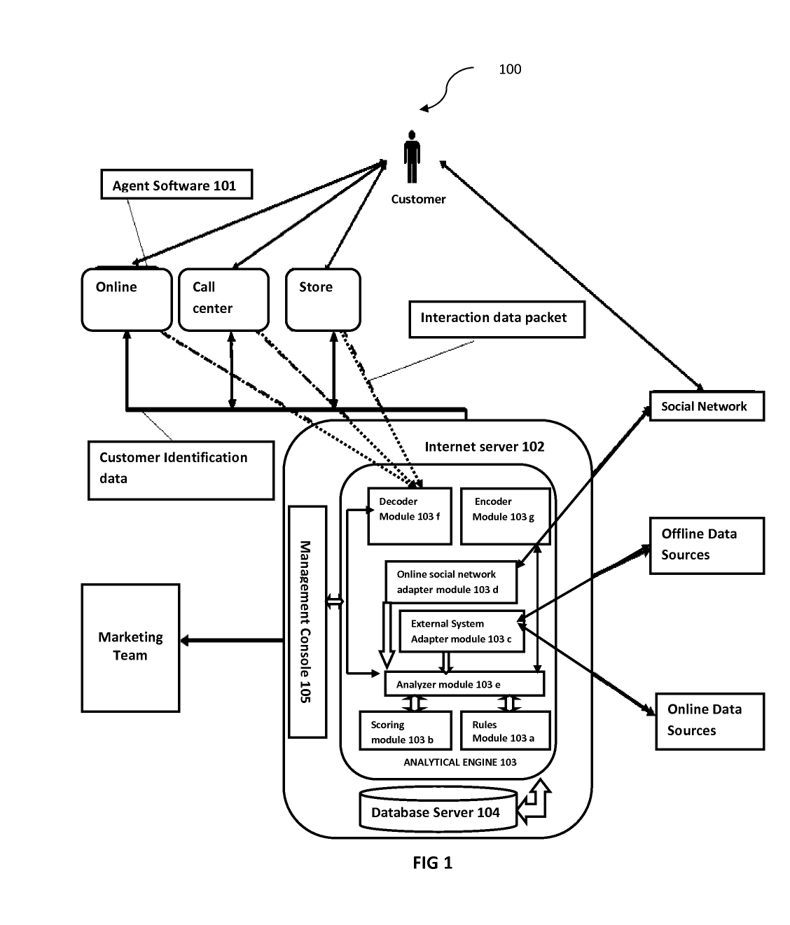

FIG. 1 is a block diagram which illustrates the sample network environment within which system for customer evaluation and retention is implemented in accordance with one or more embodiments of the invention. In one embodiment, the customer evaluation and retention system (100) comprises agent software (101) which is software that contains code for creation of the interaction data packet. This interaction data packet specifies the details of all the actions performed by the customer. All internet enabled customer touch-points for e.g. Store, Call Center, Online website, Kiosk, Smart phones, Smart TV etc., where customers may perform transactions will be running a version of the agent software (101). The internet server (102) houses the software for the scoring system. It also hosts the Management Console Application (105), and the database server that contains details about respective customers.

The analytical engine software (103) is a data overlay application which imports data from agent software (101)deployed across all customer touch points and retrieves the scores for each transaction to build unified customer identification data. The Analytical engine software (103) is assisted by rule module (103 a) that stores all the conditions necessary to perform actions, configured by the marketing manager. Depending on the actions listed by rule module (103a), the score module (103.b) assigns scores to each action listed and arrives at a cumulative count. Various attributes of customer are considered by score module (103b) while assigning score.

The external system adapter module (103c) is responsible for connecting to other data sources, for example, online data sources and offline data sources. As various external touch points are offered by different vendors so the external adapter module (103c) assists in coordinating among different data sources for retrieving customer information for purpose of further analysis by scoring module (103b) that is deployed in the analytical engine software (103).

The online social network adapter module (103d) is responsible for connecting to external customer touch-points like online social communities, groups and forums to get behavior, psychographics and sentiment Data. This new social network variable i.e. sentiment increases the accuracy in predicting customer retention. Customer retention rate is calculated based on recency, frequency, monetary (RFM) model along with customer sentiment across all touch-points, along with churn trends that provide better insight about the customer's behavior pattern.

The analyzer module (103e) takes the data from all the sources like encoder module (103f), online social network adapter module (103d), external system adapter module (103c), scoring module (103b) and returns the final updated customer identification data, that is sent back to the agent software (101) that provides real time up-to-date customer information to various touch points.

The string encoder module (103f) converts the recorded interaction data to Java script object notation (JSON) language. JSON is a text-based language independent open standard designed for human-readable data interchange. The JSON format is the most popular method in the prior art which is used for serializing and transmitting structured data over a network connection.

The decoder module (103g) receives the updated customer identifier data and decodes it before sending to the customer identifier publisher module (203) of the agent software (101) which is deployed in all the internet enabled touch points.

The database server (104) stores unique data of each customer and communicates with the analytical engine (103) of the system for customer evaluation and retention (100).

The management console (105) is a web Application provided to the business users, where the user can configure score range for every interaction, behavior and transactions. The scores defined in this system are used for scoring customer interactions and is used to auto-segment for real-time actions based on score ranges set by the business user.

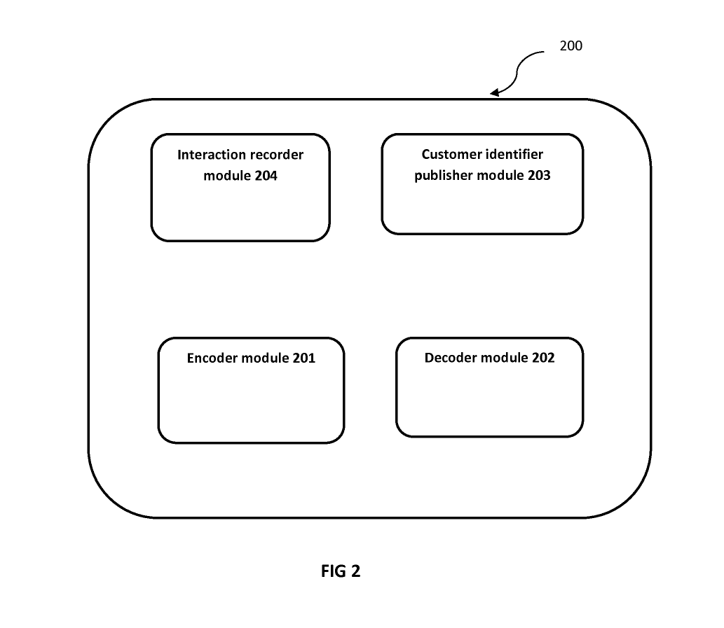

FIG. 2 is a block diagram which illustrates the agent software component (101) of the system for customer evaluation and retention in accordance to one or more embodiments of the invention. The encoder module (201) deployed in agent software (101) performs the same function as it does in the analytical engine software (103). The encoder module (201) in each case is configured to convert the recorded interaction string to JSON format. Similarly, the decoder module (202) deployed in agent software (101) performs the same function as it does in the analytical engine software (103).The decoder module (202) receives the updated customer identifier data and decodes it into a user friendly format before sending to the Customer identifier publisher module (203).

The interaction recorder module (204) is deployed in the agent software (101) and is responsible for creation of the interaction data packet. The interaction recorder module (204) records all actions performed by the customer and prepares the data for sending to server for processing. There are three kinds of touch points therefore there are basically three types of interaction data for call center, store and online websites.

The customer identifier publisher module (203) is configured to send the customer identifier in a user friendly format to all the subscribing applications at the customer touch-points.

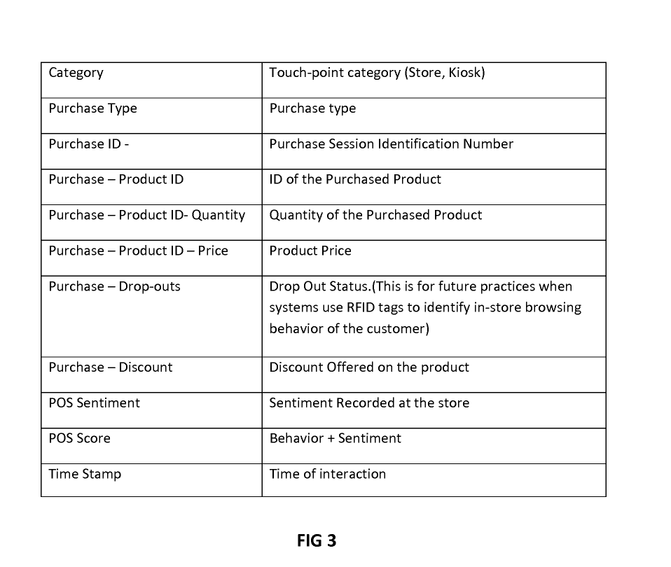

The functionality of interaction recorder module (204) in terms of creating interaction data packet by gathering all actions performed by the customer while doing transaction in a Kiosk or a store is depicted in form of a table in FIG. 3. The table shown in FIG. 3 describes various attributes that will be captured to assess customer behavior, and interaction while doing a transaction at a particular time such as purchase type, purchase ID, product ID, Product quantity, product price, purchase drop outs, purchase discounts, customer sentiments, time of transaction etc.

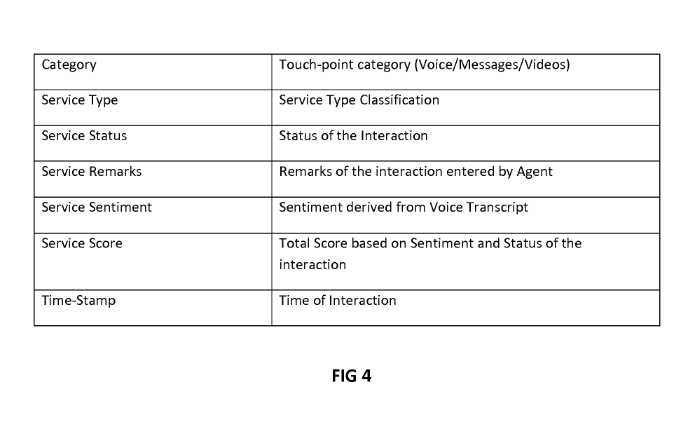

FIG. 4 is a table that describes various attributes considered by the interaction recorder module (204) while capturing customer's information for various transactions that takes place in the store such as service type, service status, service remarks, customer sentiment and time of transaction etc.

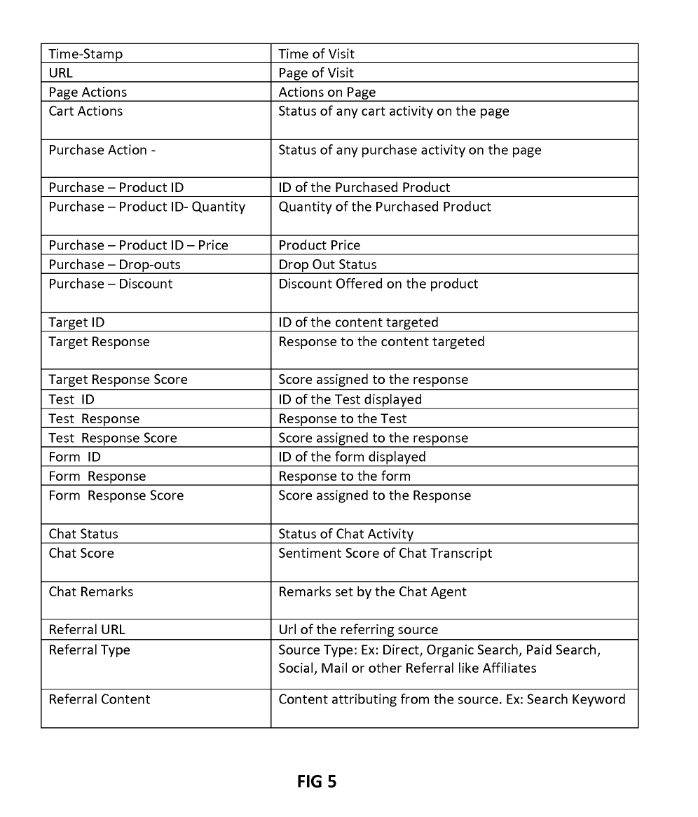

FIG. 5 is a table that shows various attributes captured by the interaction recorder module (204) while a customer undergoes a transaction online over website or mobile using URL of the website, page actions, cart actions, purchase action, product ID, price of product purchased, purchase drop outs, purchase discount, target ID, target response, target response score, chat status, chat score, chat remarks, referral URL, referral type, referral content etc.

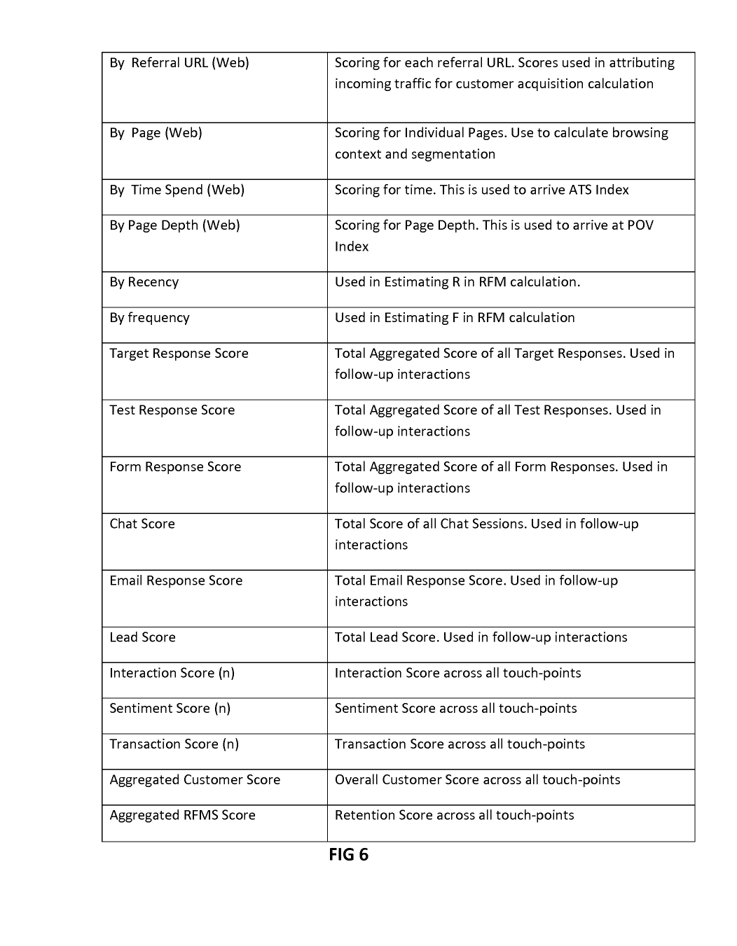

FIG. 6 is a table that describes various scoring attributes that is considered by the score module (103b) while assigning score such as referral URL, web page, time spend on web page, depth of web page, recency, frequency, target response score, form response score, chat score, email response score, lead score, interaction score, sentiment score, transaction score etc. The score module (103b) assigns scores to each attributes listed above and arrives at an aggregated score based on models defined by the marketing professional. The scoring is done based on interaction data obtained by the interaction recorder module (204) that captures all actions specific to customer's interaction and behavior while doing transactions in any of the touch points.

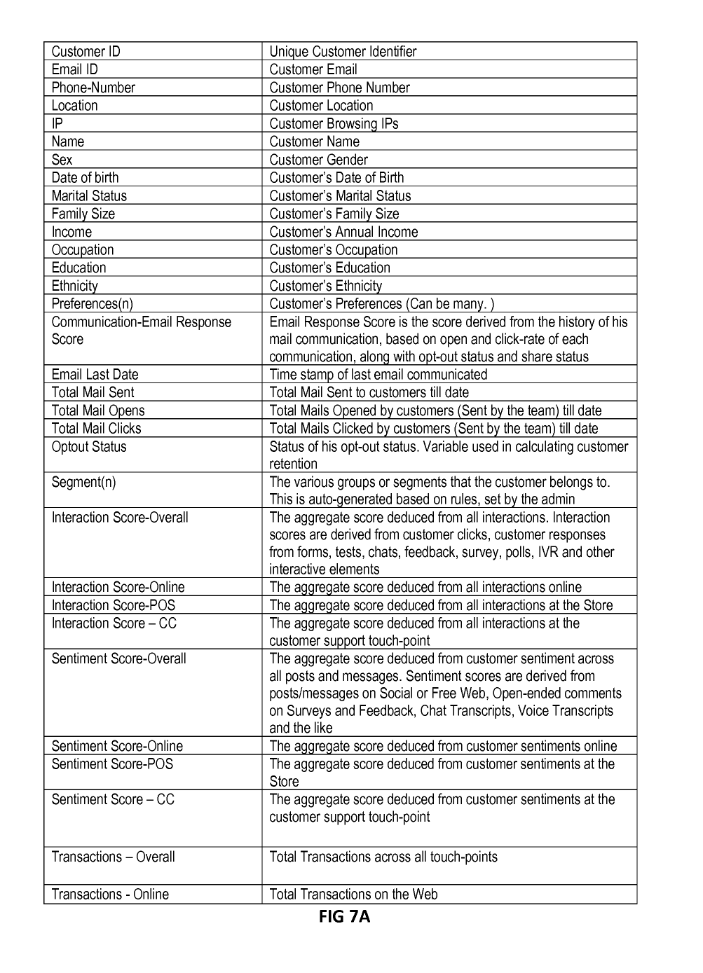

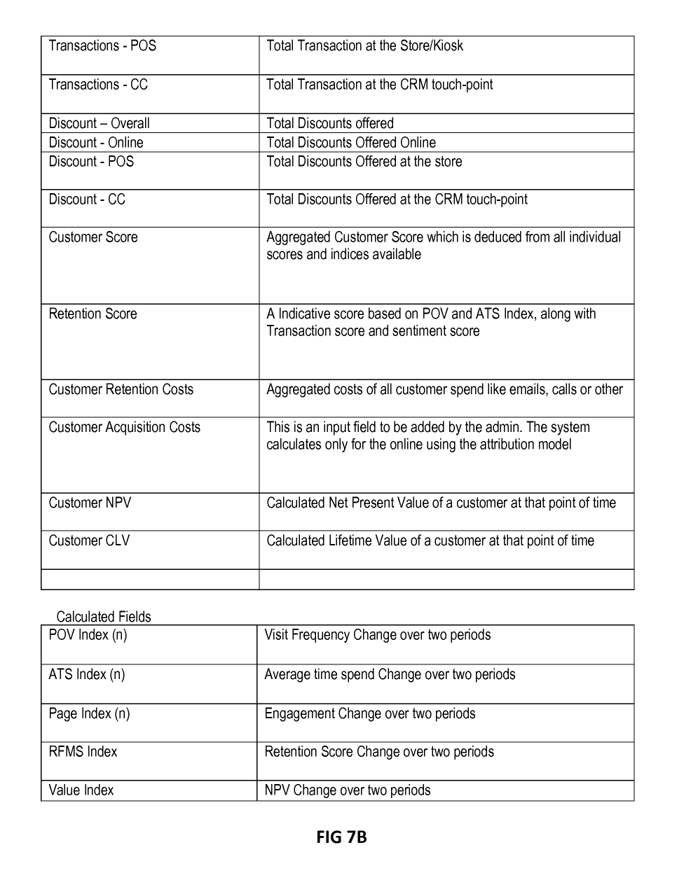

FIGS. 7A-7B are a table that describes various attributes related to customer that is stored in the database such as unique customer data, customer email, customer phone number, customer location, customer browsing IPs, customer name, customer gender, customer's date of birth, customer's marital status, customer's family size, customer's annual income, customer's occupation, customer's education, customer's ethnicity, customer's preferences, email response score, time of email communication, total mail sent to customer, total mail opened by customer, total emails clicked by customer, segments to which customer belongs, aggregate score of interactions, aggregate sentiment score, total transactions across all touch points, total discount offered, retention score, customer retention cost, customer acquisition cost, customer net present value, lifetime value of a customer at that point of time etc.

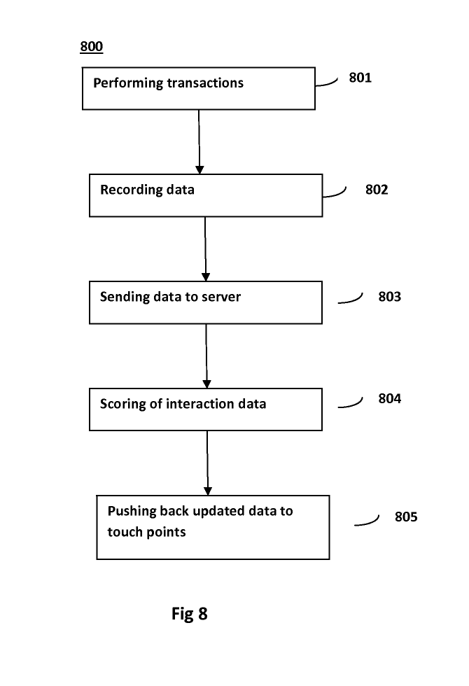

FIG. 8 shows a flowchart depicting steps in a method of customer evaluation and retention in accordance with the invention. At step 801, the customer performs transactions at different touch points that includes store, kiosk, online over website or using mobile phones. At step 802 these touch points are configured to record the interaction data for every customer that includes each and every action performed by the customer during transactions such as customer buying behavior, customer sentiments etc. At step 803, the recorded interaction data is sent to the server for further processing and analysis, this is the place where score is assigned to the interaction data based on some attributes and rules. At step 804, scoring of customer's interaction data are done by the score module deployed in the server and finally at step 805, the updated data for respective customer is pushed back to various touch points. In this way customer's net present value is available to all touch points in real time that helps the business owners in retaining their customers and builds a long term relationship with the potential customers.

The system for customer evaluation and retention equips business owners with real time data of customer evaluation which assists them in formulating and executing retention program for potential customers. The real time data available to business owners is more useful and reliable as the data is obtained and integrated from various transaction sources used by the customers. The business owners are in a better position to find out lifetime value of a particular customer based on the real time data available. Business owners can automate processes to optimize customer conversions, thus eliminating human intervention.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

We claim:

1. A method for customer evaluation of individual customers performing transactions at various touch points and real time delivery of updated customer information to the touch points, the method comprising the steps of:
a) recording interaction data for each customer;
b) sending interaction data to the server for further processing and analysis;
c) scoring interaction data based on customer behaviour, interactions and sentiments;
d) pushing back the updated data of respective customers to various touch points.

2. The method as claimed in claim 1, wherein said touch points is at least one of:
a. store;
b. call center;
c. online website;
d. kiosk;
e. smartphones; or
f. Smart TV.

3. The method as claimed in claim 1, wherein each and every action related to customer's interaction during a transaction taking place at any of the touch point is recorded and is sent to the server for processing.

4. The method as claimed in claim 1, wherein said server receives customer's interaction data and assigns them scores on the basis of customer behavior, interactions, responses and transaction.

5. The method as claimed in claim 4, wherein said scoring data may be configured by the business owners.

6. The method as claimed in claim 1, wherein said updated data is the customer's interaction data along with assigned scores which is sent back to all touch points for real time access which helps in achieving better customer retention.

7. A system for customer evaluation of individual customers performing transactions at various touch points and real time delivery of updated customer information to these touch points, the system comprising:
an agent system deployed in plurality of touch points wherein the agent system receives and records all the data concerning customer's interaction during the transaction and further transmits data to analytical engine housed in a server for scoring;
an analytical engine configured to assign score to interaction data packet received from said agent system based on different attributes;
an analyzer module configured to return the final updated customer information to all the touch points wherein the customer information is further used by business owners for formulating customer retention programs.

8. The system as claimed in claim 7, wherein said agent system further comprises interaction recorder module responsible for recording customer's interaction data and converts the data into interaction data packet with the help of encoder module deployed in the said agent system.

9. The system as claimed in claim 7, wherein said analytical engine comprises score module that assigns score to received interaction data packet depending on various scoring attributes wherein said attributes are configured by business owners.

10. The system as claimed in claim 7, wherein said agent system comprises decoder module that receives the updated customer's interaction data and publishes said data at touch points via publisher module in a language friendly format wherein the data is further used by business owners to formulate customer retention strategies.
